(19) United States
(12) Patent Application Publication
(10) Pub. No.: US 2001/0004989 A1
(43) Pub. Date: Jun. 28, 2001

(54) Friction stir welding tool

(76) Inventors: Masakuni Ezumi, Kudamatsu (JP); Kazushige Fukuyori, Kudamatsu (JP); Akihiro Satou, Hitachi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/791,856

(22) Filed: Feb. 26, 2001

(30) Foreign Application Priority Data
May 26, 1999 (JP) H11-145760

(51) Int. Cl. B23K 20/12

(52) U.S. Cl. 228/2.1; 228/112.1

(57) ABSTRACT

The present invention aims to provide a tool provided with a cutter for removing flashes produced during friction stir welding.

A first member 20 is abutted against a second member 30 at a weld end portion 40, and welding by a friction stir welding tool 100 is performed upon projections 22, 32 formed on each of the members. The friction stir welding tool 100 is equipped with a cylindrical body 110, and at least one flash cutter 150 formed integrally to the outer periphery of the body 110. When the tool 100 is rotated, the flashes produced by friction stir welding are removed as chips 62.

### FIELD OF THE INVENTION

The present invention relates to a tool for use in friction stir welding.

### DESCRIPTION OF THE RELATED ART

A friction stir welding is a welding method of rotating and rubbing a cylindrical tool made of a material harder than the material to be welded against a welding region, thereby plasticising and fluidizing the welding region with friction heat and pressure generated at the rubbed region. The technique is disclosed in Japanese Patent National Publication of a PCT Application No. 7-505090 (EP 0615480B1), for example.

FIG. 6 indicates the structure of a leading end of a tool used in friction stir welding, and FIG. 7 shows the outline of friction stir welding.

The tool 10 includes a cylindrical body 12 and a small-diameter projection 14 projecting coaxially with the body from the leading end of the body 12. The projection is also called a probe.

A first member 20 and a second member 30 being the object of welding is abutted against each other at weld end portions 40, respectively, and are fixed on the table of the welding device.

To the vicinity of the weld end portion 40 of the first member 20, there is provided a projection 22 formed by increasing the thickness size of the member extending in the welding direction. To the vicinity of the weld end portion 40 of the second member 30, there is provided a projection 32 similar to that of the first member.

The friction stir welding tool 10 performs friction stir welding, by being driven and rotated in the direction of arrow R, and by being moved relative to the member in the welding direction shown by arrow A, thereby forming a welding bead 50.

To the outer edge portion of the welding bead 50 formed by the friction stir welding, there remain flashes 60. The flashes 60 must be removed during the after process.

### SUMMARY OF THE INVENTION

A friction stir welding tool provided with a function of removing flashes is proposed in Japanese Patent Laid-Open No. 10-71477 (U.S. Pat. No. 5,794,835), for example.

The present invention provides a friction stir welding tool having simple structure, and higher rigidity.

The friction stir welding tool of the present invention is equipped with a cylindrical body, a small-diameter projection formed coaxially with the body at the leading end of the body, and at least one flash cutter provided at the outer periphery of the leading end of the body for removing flashes produced during friction stir welding. The flash cutter is formed integrally to said body by applying cutting to the outer periphery of the body.

Also, a cutting edge of the flash cutter is provided in a direction orthogonal to the axis of the body.

Moreover, the cylindrical body includes a small-diameter body integrally formed with said flash cutter, and a large-diameter body continuing from the small-diameter body, and the outer diameter size of the large-diameter body is approximately the same size as the outer diameter size of the flash cutter.

### BRIEF DESCRIPTION OF THE DRAWINGS

FIG. 1 is an explanatory view showing the outline of the friction stir welding tool according to the present invention;

FIG. 2 is an explanatory view showing welding by the friction stir welding tool according to the present invention;

FIG. 3 is a side view of the friction stir welding tool according to the present invention;

FIG. 4 is a right side view of FIG. 3;

FIG. 5 is a bottom view of FIG. 3;

FIG. 6 is an explanatory view of conventional friction stir welding tool; and

FIG. 7 is an explanatory view showing welding by the conventional friction stir welding tool.

### DETAILED DESCRIPTION OF PREFERRED EMBODIMENTS

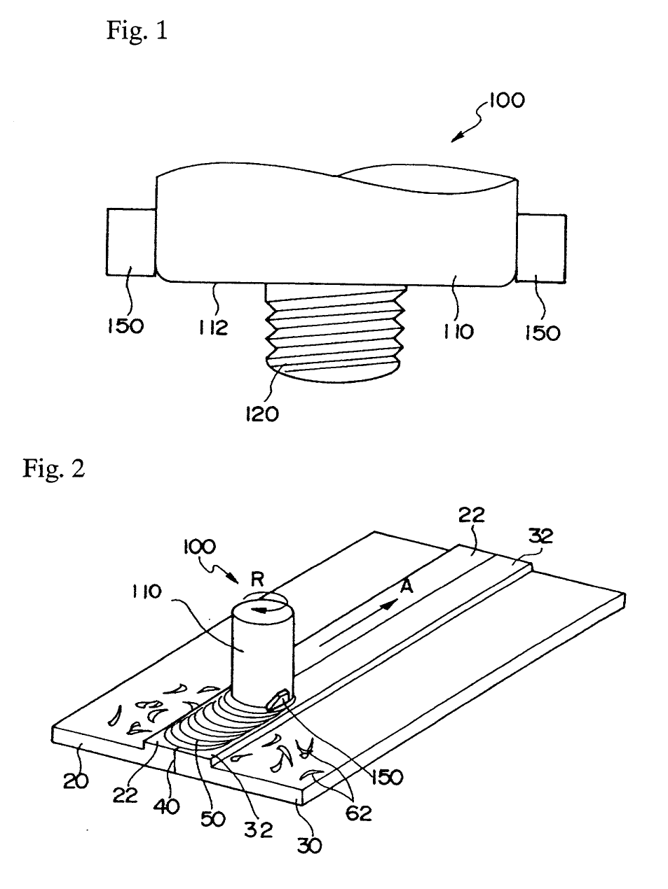

FIG. 1 is an explanatory view showing the outline of the friction stir welding tool according to the present invention, and FIG. 2 is an explanatory view showing the use of the friction stir welding tool according to the present invention.

The friction stir welding tool indicated as a whole by reference number 100 includes a cylindrical body 110, and a small-diameter projection 120 projecting along the axis of the body 110 from the leading end of body 110. The projection 120 is also called a probe. To the outer side of an end surface 112 of the body 110 on the small-diameter portion 120 side, there is equipped at least one flash cutter 150 projecting from the outer periphery of the body 110. A leading end 151 of the cutter is placed on the same surface with the end surface 112 or on the side opposite to the small-diameter portion. The number of the flash cutter is preferably selected from one or more than one.

In FIG. 2, a first member 20 and a second member 30 are abutted against each other at the welding line or a surface 40, and are provided with thick projections 22, 32 along the welding edge portion.

The tool 100 is driven and rotated in the direction of arrow R, and is moved in the direction of arrow A relative to the members 20, 30, thereby performing friction stir welding, so as to form a welding bead 50.

With such action, there are produced flashes to both rim portions of the welding bead 50. The flashes are cut out by the flash cutter provided to the outer periphery of the tool 100, and are removed from the welding bead 50 as chips 62. The outer diameter size of the rotating orbit of the flash cutter is set at a value larger than the width size of the projections 22, 32.

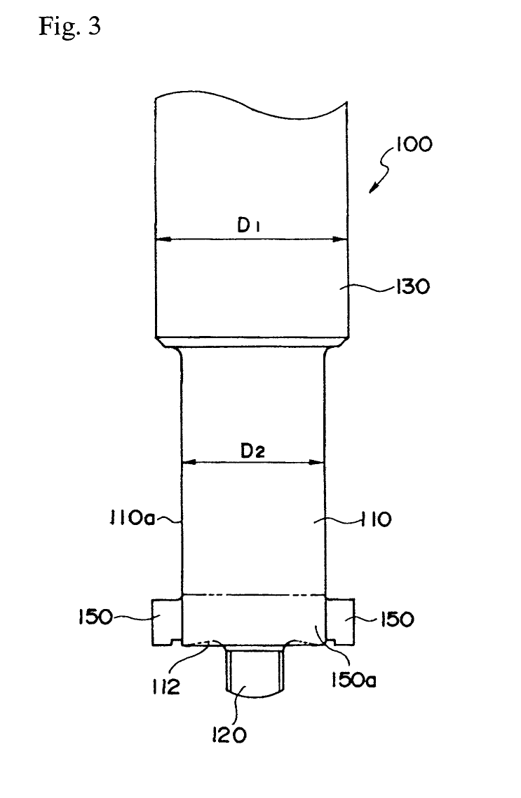

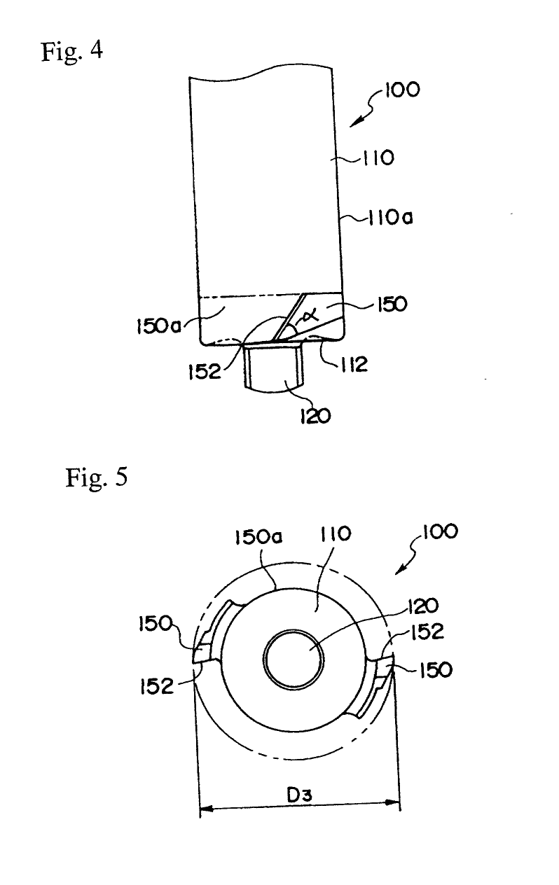

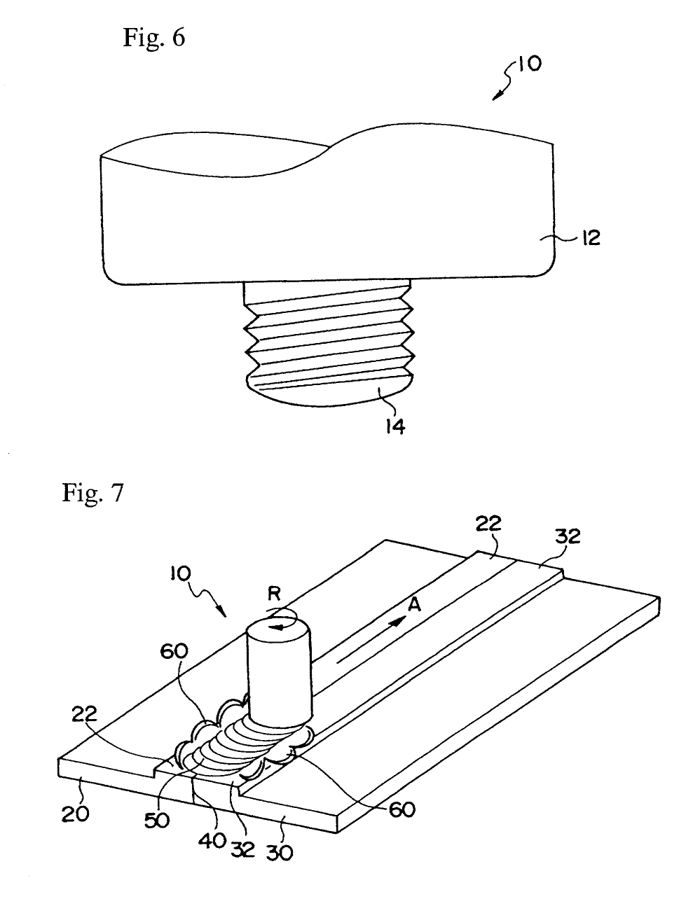

FIG. 3 is a side view of the friction stir welding tool according to the present invention, FIG. 4 is a right side view of FIG. 3, and FIG. 5 is a bottom view of FIG. 3.

The friction stir welding tool 100 includes the small-diameter body 110 and a large-diameter body 130, and also includes a projection 120 called a probe to the leading end of the small-diameter body 110. The projection 120 is formed with a screw thread, for example. The space between the small-diameter body 110 and the projection 120 is connected with a concaved bottom surface 112, for example.

The outer periphery of the leading end of the body 110 is provided with the flash cutter 150 projecting in the radius direction and being formed integrally with the body 110. The flash cutter 150 is formed by scraping out the outer peripheral surface 150a of the body 110, and is provided with a cutting edge 152 to the leading edge thereof.

That is, the large-diameter body 130 has a radius size D₁, and the small-diameter body 110 has a radius size D₂. By setting the outside diameter size of the flash cutter 150 as D₃, the outer periphery 110a of the small-diameter body 110 could be turned from the large-diameter body 130, and also the flash cutter 150 could be scraped out by milling and the like, by preparing a steel lumber having a diameter size equal to the outer diameter size D₃ of the flash cutter added with a scraping allowance as the material.

Moreover, the concaved bottom surface 112 and the projection 120 are also scraped out from the body 110.

The cutting edge 152 formed to the flash cutter 150 extends in the direction orthogonal to the axis of the body. By suitably selecting the rake angle, a flash cutter feasible to the material to be welded could be obtained.

The number of the flash cutter is selected suitably.

The friction stir welding tool of the present invention constituted the cutter for removing the flash formed during friction stir welding integrally with the body by applying cutting to the outer periphery of the body, so that the rigidity of the cutter is high, and flash-cutting with high accuracy could be performed.

Therefore, the flatness of the surface of the welded region after friction stir welding is also improved.

We claim:

1. A friction stir welding tool; wherein
said tool is equipped with a cylindrical body, a small-diameter projection formed coaxially with said body at a leading end of said body, and at least one flash cutter provided at an outer periphery of the leading end of said body for removing flashes produced during friction stir welding; and said flash cutter is formed integrally to said body by applying cutting to the outer periphery of said body.

2. A friction stir welding tool according to claim 1, wherein a cutting edge of said flash cutter is provided in a direction orthogonal to the axis of said body.

3. A friction stir welding tool according to claim 1, wherein said body includes a small-diameter body integrally formed with said flash cutter, and a large-diameter body continuing from said small-diameter body, and an outer diameter size of said large-diameter body is approximately the same size as an outer diameter size of said flash cutter.
